(19) United States
(12) Patent Application Publication
(10) Pub. No.: US 2009/0269504 A1
(43) Pub. Date: Oct. 29, 2009

(54) Flexible hardcoats and substrates coated therewith

(75) Inventor: Wen P. Liao, Clifton Park, NY (US)

Correspondence Address: MOMENTIVE PERFORMANCE MATERIALS INC.;c/o Dilworth & Barrese, LLP, 1000 Woodbury Road, Suite 405, Woodbury, NY, 11797, US

(73) Assignee: Momentive Performance Materials Inc.

(21) Appl. No.: 12/150,017

(22) Filed: Apr. 24, 2008

(51) Int. Cl. C08J 7/04

(52) U.S. Cl. 427/515

(57) ABSTRACT

A method for providing a flexible hardcoat on a substrate includes the use of a dual cure silane possessing a UV curable group and a thermally curable silane group. The dual cure silane hydrolyzed and a portion of the silanol groups are condensed with silica to provide a fluid coating composition which is then applied to a substrate. A first cure with UV radiation causes the coating to harden into a flexible hardcoat which permits the substrate to be thermoformed or embossed without damage to the coating. The substrate is then heated to thermally cure the hardcoat to provide a fully cured hard and abrasion resistant hardcoat.

### FIELD OF THE INVENTION

The present invention relates to protective coatings applied to substrates to impart hardness, mar and abrasion resistance, and particularly to a method for providing a flexible hardcoat.

### BACKGROUND OF THE RELATED ART

The substitution of glass with transparent materials which do not shatter has become widespread. For example, transparent glazing made from synthetic organic polymers is now utilized in public transportation vehicles, such as trains, buses and airplanes. Lenses for eye glasses and other optical instruments, as well as glazing for large buildings, also employ shatter resistant transparent plastics. The lighter weight of these plastics in comparison to glass is a further advantage, especially in the transportation industry where the weight of the vehicle is a major factor in its fuel economy.

While transparent plastics provide the major advantage of being more resistant to shattering and lighter than glass, a serious drawback lies in the ease with which these plastics mar and scratch due to everyday contact with abrasives, such as dust, cleaning equipment and/or ordinary weathering. Continuous scratching and marring results in impaired visibility and poor esthetics, oftentimes requiring replacement of the glazing of lens.

Attempts have been made to improve the abrasion resistance of these transparent plastics. For example, coatings formed from mixtures of silica, such as colloidal silica or silica gel, and hydrolysable silanes in a hydrolysis medium have been developed to impart scratch resistance. U.S. Pat. Nos. 3,708,225, 3,986,997, 3,976,497, 4,368,235, 4,324,712, 4,624,870 and 4,863,520 describe such compositions and are incorporated herein by reference.

Mar resistance of thermoplastics is typically imparted by coating said plastic with a UV or thermal hardcoat. The abrasion resistance is often a result of extremely high crosslinking density of the coatings. In many commercial hardcoat products, reactive nanoparticles, such as the most commonly used colloidal silica, are also incorporated into the coating by chemical bonding. The resulting compositions are usually very rigid upon curing. Bending or re-shaping the hardcoated plastic sheet leads to microcracking. For this reason, hardcoatings are typically used on flat thermoplastics or pre-shaped articles. However, there is a strong desire in the industry to manufacture mar-resistant articles by thermoforming pre-hardcoated thermoplastic sheets. This is especially true for applications involving coating complex shapes where conventional coating processes have difficulties applying lacquer evenly to completely cover all surfaces. Therefore, there is a need in the thermoforming industry to create a formable hardcoat that provides strong abrasion resistance and, in the meantime, flexible enough to be reshaped without microcracking.

### SUMMARY OF THE INVENTION

A method for providing a flexible hardcoat on a substrate is provided herein which comprises

(a) providing a dual curable organosilane possessing a UV curable group, a thermally curable silane group, and a bridging group having at least two carbon atoms connecting the UV curable group and the thermally curable silane group.

(b) carrying out acid hydrolysis of the dual curable organosilane in the presence of water and a solvent to convert the silane group to a corresponding silanol group to provide an organosilanol;

(c) condensing no more than a portion of the silanol groups of step (b) with —OH groups present on the surface of the silica particles to covalently bond the organosilanol with the silica;

(d) combining a photoinitiator and a thermal curing catalyst with the organosilanol resulting from the condensing step (c) to provide a fluid coating mixture.

(e) applying the fluid coating mixture to a substrate;

(f) drying the coating mixture;

(g) subjecting the dried coating mixture to UV radiation to crosslink the UV curable groups of the organosilanol to provide a hardcoat having sufficient flexibility to permit forming of the coated substrate without damage to the hardcoat; and

(h) heating the coated substrate of step to a temperature sufficient to bring about condensation of uncondensed silanol groups to provide a fully cured hardcoat.

### DETAILED DESCRIPTION OF THE PREFERRED EMBODIMENTS(S)

Other than in the working examples or where otherwise indicated, all numbers expressing amounts of materials, reaction conditions, time durations, quantified properties of materials, and so forth, stated in the specification and claims are to be understood as being modified in all instances by the term “about.”

It will also be understood that any numerical range recited herein is intended to include all sub-ranges within that range.

It will be further understood that any compound, material or substance which is expressly or implicitly disclosed in the specification and/or recited in a claim as belonging to a group of structurally, compositionally and/or functionally related compounds, materials or substances includes individual representatives of the group and all combinations thereof.

The invention relates to a dual cure hardcoat composition. In one embodiment the composition includes acrylate functionality to be radically cured with a UV source in the presence of a photoinitiator and silanols or alkoxy silanes to be thermally cured by a condensation reaction. Thus, in a sol-gel process, an organosilane containing a UV curable group is hydrolyzed in the presence of water, an aqueous dispersion of solid nanoparticles such as silica or other metal oxides in an acidic condition. A limited level of condensation is allowed to occur between organsilane molecules and colloidal silica particles. A solvent or solvents are carefully selected to prevent reacting products from precipitating out of the solution. Photoinitiators capable of initiating radical polymerization in the presence of UV sources is added. Likewise, a catalyst capable of catalyzing thermal curing of silanols optionally can be added to speed up curing. A leveling agent, typically silicone or fluoro surfactant, can be added to improve coatability. If weatherable hardcoat is desired, UV absorbers can also be added. Acrylates of either monofunctional or multifunctional containing low acrylate functionality per weight can also be added to further improve the flexibility of the coating.

The catalyzed formula is coated on thermoplastic sheets and solvents are allowed to flash off. When the air dried coating is subjected to UV irradiation, polymerization occurs on the acrylate or acrylamide groups that attached to the organosilanes that went through moderate level of condensation polymerize to linear, branched or lightly crosslinked structures. At this point, the composition is sufficiently crosslinked to enable some abrasion resistance yet not enough to completely tight up the polymer chains to become rigid network. Thus, a thermoplastic coated and UV cured to this stage will have sufficient mechanical integrity and abrasion-resistance for normal handling. The coated sheet can then be cut and thermforming or embossing into pre-determined shapes without concerns of cracking of the coating. Once the shapes of the article are formed, heating will further cure the coating by condensation reaction of the remainder silanols in the same manner as a typical thermal hardcoat curing. Alternatively, the coated sheet can be formed into a desired shape with a combination of UV radiation and heat. After the dual cure processes, the coating is fully developed to provide excellent mar and abrasion resistance.

More particularly, the organosilane includes a UV curable group, and a silane group connected by a bridge containing at least two carbon atoms. The UV curable group is preferably selected from acrylates, methacrylate, methacrylamide and vinyl. The silane group is preferably an alkoxysilane group such as trimethoxysilane, or triethoxysilane. The bridging group —(CH₂)ₙ— is preferably a propyl group and imparts flexibility to the coating. In a preferred embodiment, the organosilane has the formula (I):

R—(CH₂)ₙ—Si(OR¹)ₘ(R²)₃₋ₘ (I)

wherein R is a monovalent radical selected from acrylate, methycrylate, methacrylamide, acrylamide, vinyl or epoxide groups, and having from 0 to about 10 carbon atoms. The value of n is greater than or equal to 0. Preferably, n is from 0 to about 5. In an embodiment of the invention n is from 3 to 5.

R¹ and R² are each independently a monovalent alkyl radical of from 1-8 carbon atoms or aryl radical of from 6-20 carbon atoms and are preferably methyl, ethyl, propyl, or butyl, and m is 1 to 3, and preferably m is 3.

Preferred organosilanes for use in the present invention include methacryloxypropyltrimethoxysilane (commercially available under the designation Silwet A-174), methacryloylaminopropyltriethoxysilane (commercially available under the designation Silwet Y-5997), vinyltrimethoxysilane, gamma-glycidoxypropyltrimethoxysilane, or 3,4-epoxycyclohexlethyltrimethoxysilane (commercially available under the designation Silwet A-186).

In one embodiment the acid hydrolysis is carried out in the presence of water. In another embodiment the acid hydrolysis is carried out in the presence of an aqueous dispersion of silica. The silica employed comprises nanosized silica particles such as colloidal silica, silica gel or fumed silica having an average particle diameter preferably ranging from about 5 to 150 millimicrons. Typically such silica particles have —OH groups attached to their surface, thus providing silanol (Si—OH) functionalities.

In another embodiment the acid hydrolysis is carried out in the presence of an aqueous dispersion of nanosized (average particle diameter of 5-150 millimicrons) particles of one or more of zinc oxide, aluminum oxide, titanium oxide, tin oxide, antimony oxide, copper oxide, iron oxide, bismuth oxide, cerium oxide, lanthanum oxide, praseodymium oxide, neodymium oxide, samarium oxide, zirconium oxide, yttrium oxide, and physical or chemical combinations thereof. Such oxides suitable for use in the present invention are available from Nanophase Technologies Corporation of Romeoville, Ill.

In a first step acid hydrolysis followed by condensation of the organosilane is carried out. In one embodiment, the organosilane is combined with an acid hydrolysis catalyst and a solvent. The acid can be, for example, acetic acid, hydrochloric acid or any other suitable acid at an appropriate concentration. Various suitable acids are disclosed in U.S. Pat. No. 4,863,520. The solvent can be an alcohol (methanol, ethanol, propanol, isopropanol, n-butanol, tert-butanol, methoxypropanol, ethylene glycol, and/or diethylene glycol butyl ether) or other water miscible organic solvents such as acetone, methyl ethyl ketone, ethylene glycol monopropyl ether, and 2-butoxy ethanol. The silica is separately combined with water to form an aqueous dispersion and slowly added to the organosilane solution with mixing. More acid is added if necessary, to adjust the pH to 4-5. After further mixing for a period of time of from 8-48 hours during which hydrolysis and condensation takes place, more solvent can be added, optionally with further acidification. Preferably, to the mixture is then added a thermal cure catalyst, a photoinitiator, leveling agent, UV absorber, flexibility improvers and the like.

The aqueous dispersions of colloidal silica which can be utilized in the present invention have a particle size of from 2-150 millimicrons and preferably from 5-30 millimicrons average diameter. Such dispersions are known in the art and commercially available ones include, for example, those under the trademarks of Ludox (DuPont), Snowtex (Nissan Chemical), and Bindzil (Akzo Nobel) and Nalcoag (Nalco Chemical Company). Such dispersions are available in the form of acidic and basic hydrosols. The commercially available basic colloidal silicasols typically provide a sufficient quantity of base to maintain the pH within the range of 7.1 to 7.8. Therefore, when utilizing the colloidal silicas, it is preferable that the alkaline species within the silica be volatile at the selected cure temperature.

Colloidal silicas which are initially acidic can also be used. Colloidal silicas having a low alkali content provide a more stable coating composition and these are preferred. A particularly preferred colloidal silica for purposes herein is known as Ludox AS, an ammonium stabilized colloidal silica sold by DuPont Company. Other commercially available ammonium stabilized colloidal silicas include Nalcoag 2326 and Nalcoag 1034A, sold by Nalco Chemical Company.

The preferred thermal cure catalyst is a tetrabutylammonium carboxylate of the formula (II):

[(C₄H₉)₄N]⁺[OC(O)—R]⁻ (II)

Wherein R is selected from the group consisting of hydrogen, alkyl groups containing about 1 to about 8 carbon atoms, and aromatic groups containing about 6 to 20 carbon atoms. In preferred embodiments, R is a group containing about 1 to 4 carbon atoms, such as methyl, ethyl, propyl, butyl, and isobutyl. Exemplary catalysts of formula (II) are tetra-n-butylammonium acetate (TBAA), tetra-n-butylammonium formate, tetra-n-butylammonium benzoate, tetra-n-butylammonium-2-ethylhexanoate, tetra-n-butylammonium-p-ethylbenzoate, and tetra-n-butylammonium propionate. In terms of effectiveness and suitability for the present invention, the preferred cure catalysts are tetra-n-butylammonium acetate and tetra-n-butylammonium formate, with tetra-n-butylammonium acetate being most preferred.

Photoinitiators suitable for use in the invention are those which promote polymerization of the (meth)acrylate or epoxide upon exposure to UV radiation. Such photoinitiatives available under the designations IRGACURE® or DAROCUR™ from Ciba Specialty Chemicals or LUCIRIN® available from BASF or ESACURE®. Other suitable photoinitiators include ketone-based photoinitiators such as alkoxyalkyl phenyl ketones, and morpholinoalkyl ketones, as well as benzoin ether photoinitiators. Additional photoinitiators include onium catalysts such as bisaryliodonium salts (e.g. bis(dodecylphenyl)iodonium hexafluoroantimonate, (octyloxyphenyl, phenyl)iodonium hexafluoroantimonate, bisaryliodonium tetrakis(pentafluorophenyl)borate), triarylsulphonium salts, and combinations thereof. Preferably, the catalyst is a bisaryliodonium salt. Also useful herein as curing agents for epoxy resin monomer(s) are the superacid salts, e.g., the urea-superacid salts disclosed in U.S. Pat. No. 5,278,247, the entire contents of which are incorporated by reference herein. The photoinitiatives is preferably present in the composition in a concentration which will not noticeably discolor the cured composition.

The composition can also include surfactants as leveling agents. Examples of suitable surfactants include fluorinated surfactants such as FLUORAD from 3M Company of St. Paul, Minn., and polyethers under the designation BYK available from BYK Chemie USA of Wallingford, Conn.

The composition can also include UV absorbers such as benzotriazoles. Preferred UV absorbers are those capable of co-reacting with silanes. Such UV absorbers are disclosed in U.S. Pat. Nos. 4,863,520, 4,374,674 and 4,680,232, which are herein incorporated by reference. Specific examples include 4-[gamma-(trimethoxysilyl)propoxyl]-2-hydroxy benzophenone and 4-[gamma-(triethoxysilyl)propoxyl]-2-hydroxy benzophenone and 3-(4,4,4-triethoxy-4-silabutyl)-2,4-dihydroxy-5-(phenylcarbonyl)phenyl phenyl ketone.

The composition can also include antioxidants such as hindered phenols (e.g. IRGANOX 1010 from Ciba Specialty Chemicals), dyes (e.g. methylene green methylene blue and the like), fillers and other additives.

Flexibility improvers can include monofunctional or multifunctional acrylates, as mentioned above.

The temperature of the reaction mixture is generally kept in the range of about 20° C. to about 40° C., and preferably below 25° C. As a rule, the longer the reaction time permitted for hydrolysis, the higher the final viscosity.

Silanols, R¹Si(OH)₃, are formed in situ as a result of admixing the corresponding organotrialkoxysilanes with the aqueous dispersion of colloidal silica. Alkoxy functional groups, such as methoxy, ethoxy, isopropoxy, n-butoxy, and the like generate the hydroxy functional group upon hydrolysis and liberate the corresponding alcohol, such as methanol, ethanol, isopropanol, n-butanol, and the like.

Upon generating the hydroxyl substituents of these silanols, a condensation reaction begins to form silicon-oxygen-silicon bonds. This condensation reaction is not exhaustive. The siloxanes produced retain a quantity of silicon-bonded hydroxy groups, which is why the polymer is soluble in the water-alcohol solvent mixture. This soluble partial condensate can be characterized as a siloxanol polymer having silicon-bonded hydroxyl groups and—SiO—repeating units.

More particularly, not all of the alkoxy groups of the organosilane are condensed. The degree of condensation is characterized by the T³/T² ratio wherein T³ represents the amount of organosilane condensed with other silane or silanols with three alkoxy-groups and T² represents the amount of organosilane condensed with other silane or silanols with two alkoxy groups. The T³/T² ratio can range from 0 to 3, and is preferably 0.05 to 2.5, and more preferably from about 0.1 to about 2.0.

After hydrolysis has been completed, the solids content of the coating compositions is typically adjusted by adding alcohol to the reaction mixture. Suitable alcohols include lower aliphatics, e.g., having 1 to 6 carbon atoms, such as methanol, ethanol, propanol, isopropanol, butyl alcohol, t-butyl alcohol, methoxy propanol and the like, or mixtures thereof. Isobutanol is preferred. A solvent system i.e., mixture of water and alcohol, preferably contains from about 20-75% by weight of the alcohol to ensure that the partial condensate is soluble.

Optionally, additional water-miscible polar solvents, such as diacetone alcohol, butyl cellosolve, and the like can be included in minor amounts, usually no more than 20% by weight of the solvent system.

After adjustment with solvent, the coating compositions of this invention preferably contains from about 10-50% by weight solids, most preferably, about 20% by weight of the total composition. The nonvolatile solids portion of the coating formulation is a mixture of colloidal silica and the partial condensate of a silanol. In the preferred coating compositions herein, the partial condensate is present in an amount of from about 40-75% by weight of total solids, with the colloidal silica being present in the amount of from about 25-60% by weight based on the total weight of solids within the alcohol/water cosolvent.

The coating compositions of this invention preferably have a pH in the range of about 4.0 to 6.0 and most preferably from about 4.5 to 5.5. After the hydrolysis reaction, it may be necessary to adjust the pH of the composition to fall within these values. To raise the pH, volatile bases are preferred, such as ammonium hydroxide; and to lower the pH, volatile acids are preferred, such as acetic acid and formic acid. These volatile acids having a boiling point which falls within the range of temperatures utilized to cure said compositions.

In the next step the composition is coated onto a substrate such as a plastic or metal surface. Examples of such plastics include synthetic organic polymeric substrates, such as acrylic polymers, example, poly(methylmethacrylate), and the like; polyesters, example, poly(ethylene terephthalate), poly(butylenes terephthalate), and the like; polyamides, polyimides, acrylonitrile-styrene copolymer, styrene-acrylonitrile-butadiene terpolymers, polyvinyl chloride, polyethylene, and the like.

Special mention is made of the polycarbonates, such as those polycarbonates known as Lexan® polycarbonate resin, available from Sabic Innovative Plastics, including transparent panels made of such materials. The compositions of this invention are especially useful as protective coatings on the surfaces of such articles.

The fluid composition on the substrate is then allowed to dry by removal of any solvents, for example by evaporation, thereby leaving a dry coating.

Next, in a “first cure,” the dry coating is exposed to UV radiation to crosslink the (meth)acrylate, (meth)acrylamide, vinyl or epoxide groups present on the silanol that had condensed on the silica particles and such groups present on the uncondensed silanol. UV curing is performed in accordance with standard procedures for exposure to UV radiation.

At this stage, the substrate has a coating which is hard enough to provide sufficient mechanical integrity and abrasion resistance for normal handling, but which is still flexible enough to permit the coated sheet to be cut, embossed, or thermoformed into predetermined shapes without the development of cracks or fissures in the coating.

After the forming of the substrate into the desired shape the coated substrate is heated to further cure the coating in a second stage to condense the remainder of the silanol groups. Typically, the coated substrate is heated in an oven at from about 40° C. to about 200° C. for a period of time ranging from about 1 minute to about 60 minutes. After the second stage of the dual cure process of the invention the coating is fully hardened and exhibits excellent mar and abrasion resistance.

Various features of the invention are illustrated by the Examples and Comparative Examples set forth below. The Examples exemplify the invention. The Comparative Examples do not exemplify the invention but are presented for comparison purposes.

### Example 1

To a beaker equipped with a stirring bar was charged 48.6 g Silwet A-174 (methacryloxypropyltrimethoxysilane), 0.64 g acetic acid, and 33.5 g isopropanol. The inputs were mixed to a homogeneous solution at ambient conditions. In a separate beaker, 10.73 g Ludox AS-40 (an aqueous dispersion of colloidal silica) was diluted with 9.44 g deionized water. The colloidal silica dispersion was slowly added to the silane solution while mixing. After the addition was completed, 6.52 g acetic acid was added and the dispersion was allowed to mix overnight. After 16 hours of mixing at ambient conditions, 10.92 g of n-butanol was added and followed by 7.4 g isopropanol. After the two solvents were homogeneously mixed in, another 2.09 g acetic acid was added. That addition was followed by charging 3.55 g isopropanol, 0.088 g N,N,N,N-tetrabutylammonium acetate, 0.048 g polyether leveling agent (BYK 302), and 0.29 g 4-hydroxy-2,2,6,6-tetramethyl-1-piperidinol-N-oxyl (used to prevent premature radical curing).

### Example 2

To a beaker equipped with a stirring bar was charged 6.64 g Silwet A-174, 0.68 g acetic acid, and 33.9 g isopropanol. The inputs were mixed to a homogeneous solution at ambient conditions. In a separate beaker, 10.77 g Ludox AS-40 (an aqueous dispersion of colloidal silica) was diluted with 9.54 g deionized water. The colloidal silica dispersion was slowly added to the silane solution while mixing. After the addition was completed, 1.63 g acetic acid was added to adjust pH to 4.89 and the dispersion was allowed to mix overnight. After 16 hours of mixing at ambient conditions, 10.92 g of n-butanol was added and followed by 7.41 g isopropanol. After the two solvents were homogeneously mixed in, another 2.14 g acetic acid was added. That addition was followed by charging 3.57 g isopropanol 0.09 g N,N,N,N-tetrabutylammonium acetate, 0.05 g leveling agent (BYK 302), and 0.29 g 4-hydroxy-2,2,6,6-tetramethyl-1-piperidinol-N-oxyl.

### Examples 3-8

Various coating compositions to demonstrate the invention were blend under ambient conditions according to the charges shown on Table 1.

TABLE 1

| | Example 3 | Example 4 | Example 5 | Example 6 | Example 7 | Example 8 |
|---|---|---|---|---|---|---|
| Example 1 | 10 | 10 | 10 | | | |
| Example 2 | | | | 10 | 10 | 10 |
| Ebecryl 8402 | | 10 | 5 | | 10 | 5 |
| Darocur 1173 | 0.3 | 0.6 | 0.4 | 0.2 | 0.6 | 0.4 |
| Irgacure 819 | | 0.07 | 0.04 | | 0.07 | 0.04 |
| Methoxypropanol | 10 | 40 | 25 | | 30 | 10 |
| Total | 20.3 | 60.67 | 40.44 | 10.2 | 50.67 | 25.44 |

Ebecryl 8402 acrylate monomers from Cytec Industries
Daroucur 1173 and Irgacure 819 are photoinitiators from Ciba Specialty Chemicals

The coatings were flow-coated on 2 mil thick polyethylene terephthalate (PET) sheets and polycarbonate plaques and air dried for 5-15 minutes before curing. Curing was implemented either by exposure of the coated plaques to UV or UV and thermal combination. The UV curing was carried out at a Fusion UV system with UVA dosage about 7 joules/cm². Thermal curing was carried out by heating coated articles in a 130° C. oven for 1 hour.

Elongation was measured on dumbbell samples cut from coated PET sheet with Monsanto Tensometer 10. The elongation was recorded when the coating showed the initial crack. In some cases where the substrate broke before coating, the elongation at break of substrate was recorded.

Taber abrasion resistance was measured according to ASTM method D1044-99 using CS-10F wheel at 500 g-load for 500 cycles.

The results are shown below in Table 2.

TABLE 2

| Sample | Curing | % Elongation | Delta Haze, % |
|---|---|---|---|
| Example 3 | UV | 20 | 5.06 |
| Example 3 | UV + thermal | 18 | 3.89 |
| Example 4 | UV | 45 | 17.12 |
| Example 4 | UV + thermal | 22 | 16.92 |
| Example 5 | UV | 32 | 15.05 |
| Example 5 | UV + thermal | 37 | 14.51 |
| Example 6 | UV | 32* | 5.09 |
| Example 6 | UV + thermal | 17 | 3.75 |
| Example 7 | UV | 54* | 14.81 |
| Example 7 | UV + thermal | 35 | 18.07 |
| Example 8 | UV | 59* | 18.69 |
| Example 8 | UV + thermal | 54* | 21.06 |

*Underlying substrate broke while coating was still intact.

### Example 9

To a beaker equipped with a stirring bar was charged 6.62 g Silwet A-186 (3,4-(epoxycyclohexyl)ethyltrimethoxysilane), 0.69 g acetic acid, and 60 g isopropanol. The inputs were mixed to a homogeneous solution at ambient conditions. In a separate beaker, 10.74 g Ludox AS-40 (an aqueous dispersion of colloidal silica) was diluted with 9.84 g de-ionized water. The colloidal silica dispersion was slowly added to the silane solution while mixing. After the addition was complete, 1.85 g acetic acid was added to adjust pH to 4.86 and the dispersion was allowed to mix overnight. After 16 hours of mixing at ambient conditions, 10.94 g of n-butanol was added and followed by 7.42 g isopropanol. After the two solvents were homogeneously mixed in, another 2.1 g acetic acid was added. That addition was followed by charges of 3.58 g isopropanol, 0.1 g tetrabutylammonium acetate, and 0.05 g surfactant, BYK302. The solution was further mixed for another 1 hour.

### Example 10

To a beaker equipped with a stirring bar was charged 26.68 g Silwet A-186 (3,4-(epoxycyclohexyl)ethyltrimethoxysilane), 0.69 g acetic acid, and 33.51 g isopropanol. The inputs were mixed to a homogeneous solution at ambient conditions. In a separate beaker, 10.74 g Ludox AS-40 (aqueous disperson of colloidal silica) was diluted with 9.84 g de-ionized water. The colloidal silica dispersion was slowly added to the silane solution while mixing. After the addition was completed, 1.85 g acetic acid was added to adjust pH to 4.86 and the dispersion was allowed to mix overnight. After 16 hours of mixing at ambient conditions, 10.94 g of n-butanol was added and followed by 7.42 g isopropanol. After the two solvents were homogeneously mixed in, another 2.1 g acetic acid was added. That addition was followed by charges of 3.58 g isopropanol, 0.1 g tetrabutylammonium acetate, and 0.05 g surfactant, BYK302. The solution was further mixed for another 1 hour.

### Examples 11-15

Various coating compositions to demonstrate the invention were blended under ambient conditions according to the charges shown on Table 3.

TABLE 3

| | Example | Example | Example | Example | Example |
|---|---|---|---|---|---|
| | 11 | 12 | 13 | 14 | 15 |
| Example 9 | 20 | 20 | 20 | 20 | 10 |
| Example 10 | | | | | |
| UVR6000 | | 0.4 | 0.4 | | |
| UVR6128 | | | 2 | | |
| Glycerol | | | | 0.2 | |
| UVI6992 | 0.08 | 1 | 0.22 | 0.08 | |
| triethylenetetraamine | | | | | 0.044 |

*UVR6000 = 3-ethyl-3-hydroxymethyloxetane; UVR6128 = bis-(3,4-epoxycyclohexylmethyl)adipate; UVI6992 = arylsulfonium hexafluorophosphate salts, all from Dow Chemical.

The coatings were flow-coated polycarbonate panels and air dried for 5-15 minutes before curing. Curing was implemented either by exposure to UV (Examples 11-14), thermal (Example 15) or UV and thermal combination (Examples 11-14). The UV curing was carried out at a Fusion UV system with UVA dosage about 7 joules/cm². Thermal curing was carried out by heating coated articles in a 130° C. oven for 1 hour.

While the above description contains specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A method for providing a hardcoat on a substrate comprising:
(a) providing a dual curable organosilane possessing a UV curable group, a thermally curable silane group, and a bridging group having at least two carbon atoms connecting the UV curable group and the thermally curable silane group.
(b) carrying out acid hydrolysis of the dual curable organosilane in the presence of water and a solvent to convert the silane group to a corresponding silanol group to provide an organosilanol;
(c) condensing no more than a portion of the silanol groups of step (b);
(d) combining a photoinitiator and a thermal curing catalyst with the organosilanol resulting from the condensing step (c) to provide a fluid coating mixture.
(e) applying the fluid coating mixture to a substrate;
(f) drying the coating mixture;
(g) subjecting the dried coating mixture to UV radiation to crosslink the UV curable groups of the organosilanol to provide a hardcoat having sufficient flexibility to permit forming of the coated substrate without damage to the hardcoat; and
(h) heating the coated substrate of step to a temperature sufficient to bring about condensation of uncondensed silanol groups to provide a fully cured hardcoat.

2. The method of claim 1 wherein the step (b) is carried out in the presence of an aqueous dispersion of solid particles having an average particle size of from about 5 millimicrons to about 150 millimicrons and step (c) includes condensing the portion of the silanol groups of step (b) with —OH groups present on the surface of the solid particles.

3. The method of claim 2 wherein the solid particles are silica.

4. The method of claim 2 wherein the solid particles comprise one or more oxides selected from the group consisting of zinc oxide, aluminum oxide, titanium oxide, tin oxide, antimony oxide, copper oxide, iron oxide, bismuth oxide, cerium oxide, lanthanum oxide, praseodymium oxide, neodymium oxide, samarium oxide, zirconium oxide and yttrium oxide.

5. The method of claim 1 wherein the dual curable organosilane has the formula:
R—(CH₂)ₙ—Si(OR¹)ₘ(R²)₃₋ₘ
Wherein R is a monovalent radical selected from acrylate, methacrylate, acrylamide, methacrylamide, vinyl and epoxide groups having from 2 to about 10 carbon atoms; n is greater than or equal to 0; R¹ and R² are each independently a monovalent alkyl radical of from 1-8 carbon atoms or an aryl radical of from 6-20 carbon atoms; and m is 1 to 3.

6. The method of claim 5 wherein n is 3 to 5, m is 3, and R¹ is methyl, ethyl, propyl or butyl.

7. The method of claim 5 wherein n is 0, m is 3, and R¹ is vinyl.

8. The method of claim 1 wherein the dual curable organosilane is selected from methacryloxypropyltrimethoxysilane, methacryloylaminopropyltriethoxysilane, vinyltrimethoxysilane and 3,4-epoxycyclohexlethyltrimethoxysilane.

9. The method of claim 1 wherein the acid hydrolysis of step (b) is carried out in the presence of an acid selected from the group consisting of acetic acid and hydrochloric acid.

10. The method of claim 1 wherein the solvent is selected from the group consisting of methanol, ethanol, propanol, isopropanol, n-butanol, tert-butanol and methoxypropanol.

11. The method of claim 3 wherein the silica is selected from collordal silica, silica gel and fumed silica.

12. The method of claim 1 wherein the step (c) of condensing is characterized by a T³/T² ratio wherein. T³ represents the amount of organosilane condensed with other silane or silanols with three alkoxy groups and T² represents the amount of organosilane condensed with other silane or silanols with two alkoxy groups, wherein the T³/T² ratio ranges from about 0 to about 3.

13. The method of claim 12 wherein the T³/T² ratio ranges from about 0.05 to about 2.5.

14. The method of claim 12 wherein the T³/T² ratio ranges from about 0.1 to 2.0.

15. The method of claim 1 wherein the photoinitator is selected from alkoxyalkyl phenyl ketones, morpholinoalkyl-ketones, benzoin, bisaryliodonium salts and urea-superacid salts.

16. The method of claim 1 wherein the thermal curing catalyst is a tetrabutylammonium carboxylate.

17. The method of claim 1 wherein the thermal curing catalyst is selected from the group consisting of tetra-n-butylammonium acetate and tetra-n-butylammonium formate.

18. The method of claim 1 further combining one or more of leveling agents, UV absorbers, antioxidants, flexibility improvers, dyes and fillers.

19. The method of claim 18 wherein the leveling agent is a fluorinated surfactant.

20. The method of claim 18 wherein the UV absorber includes one or both of 4-[gamma-(triethoxysilyl)propoxyl]-2-hydroxy benzophenone.

21. The method of claim 18 wherein the antioxidants include hindered phenols.

22. The method of claim 18 wherein the flexibility improvers comprise monofunctional or multifunctional acrylates.

23. The method of claim 1 wherein the step (h) of heating is conducted at a temperature of from 40° C. to about 200° C.

24. The method of claim 1 wherein the substrate is a metal or a synthetic polymer.

25. The method of claim 1 further comprising forming the substrate with the flexible hardcoat of step (g) into a desired shape prior to step (h) of heating the coated substrate.

26. The method of claim 21 wherein the forming step includes thermoforming or embossing.

27. The method of claim 1 further comprising forming the substrate with the flexible hardcoat with a combination of UV radiation and heating.
